(19) United States
(12) Patent Application Publication
(10) Pub. No.: US 2006/0292423 A1
(43) Pub. Date: Dec. 28, 2006

(54) Fuel cell unit having suction port and exhaust port

(75) Inventor: Terumasa Nagasaki, Ome-shi (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Kabushiki Kaisha Toshiba

(21) Appl. No.: 11/413,913

(22) Filed: Apr. 28, 2006

(30) Foreign Application Priority Data
Jun. 22, 2005 (JP) 2005-181487

(51) Int. Cl. H01M 8/02; H01M 2/12

(52) U.S. Cl. 429/34; 429/83

(57) ABSTRACT

According to one embodiment, a fuel cell unit has a fuel cell, a fuel supply path, a suction port, and an exhaust port. The fuel cell has a fuel pole and an air pole. The fuel supply path supplies fuel to the fuel pole of the fuel cell. The suction port takes in air for generation of electric power. The exhaust port exhausts gaseous matter after generation of electric power discharged from the air pole of the fuel cell. The suction port and exhaust port are opened in the directions different from each other.

### CROSS-REFERENCE TO RELATED APPLICATIONS

This application is based upon and claims the benefit of priority from Japanese Patent Application No. 2005-181487, filed Jun. 22, 2005, the entire contents of which are incorporated herein by reference.

### BACKGROUND

1. Field

One embodiment of the invention relates to a direct methanol fuel cell unit, which supplies methanol and air to a fuel cell by using a pump.

2. Description of the Related Art

In recent years, a compact high power charge-free fuel cell unit has received much attention as a power supply for an electronic apparatus such as a portable computer. For example, a direct methanol fuel cell unit (hereinafter called DMFC: Direct Methanol Fuel Cell) to circulate methanol solution is easy to handle, and simple as a whole system compared with a fuel cell unit using hydrogen as a fuel, and is therefore preferable as a power supply particularly for an electronic apparatus.

A conventional DMFC is provided with a DMFC stack, a fuel supply path, and an air supply path. The DMFC stack has a fuel pole, an air pole, and an electrolytic film. The fuel supply path supplies methanol solution to the fuel pole of the DMFC stack. The air supply path has a suction port to take in air for generation of electric power, and supplies the air to the air pole of the DMFC stack.

In the fuel pole of the DMFC stack, methanol oxidizes by reacting with water, and generates carbon dioxide, hydrogen ions and electrons. The hydrogen ions penetrate the electrolytic film, and reaches the air pole. In the air pole, oxygen in the air deoxidizes by combining with the hydrogen ions and electrons, and generates water. At this time, electrons flow in an external circuit connected between the fuel pole and air pole, and electric power is generated.

The carbon dioxide generated in the fuel pole and air containing moisture discharged from the air pole are led to the exhaust path. The carbon dioxide and air are mixed in a process of flowing in the exhaust path, and released from the exhaust port. The part of the methanol penetrating the electrolytic film that was not utilized for generation of electric power and by-products such as acetaldehyde generated by the oxidizing reaction are also flowed into the exhaust path and released from the exhaust port.

According to the DMFC disclosed in Jpn. Pat. Appln. KOKAI Publication No. 8-264199, a suction port and an exhaust port are provided on the top of a case to house a DMFC stack and other components. The top of the case is covered with a lid. As a result, the suction port and exhaust port are covered with the lid, and opened to a common space enclosed by the lid and the top of the case.

The gaseous matter discharged from the exhaust port of DMFC includes impurities such as carbon dioxide, methanol and by-products with compositions different from fresh air, and these impurities affect the oxidizing reaction in the air pole. Further, the gaseous matter including impurities is low in oxygen density necessary for generation of electric power.

According to the DMFC disclosed in the above patent specification, the exhaust port is separated from the suction port, but opened to the common space enclosed by the lid and the top of the case. Thus, the gaseous matter discharged from the exhaust port is taken in again from the suction port without diffusing into the atmosphere, and the gaseous matter is inevitably supplied to the air pole of the DMFC stack.

As a result, the electric power generation capacity of the DMFC stack is lowered, and the output of DMFC cannot be increased.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a perspective view of an exemplary fuel cell unit according to an embodiment of the present invention;

FIG. 2 is an exemplary perspective view showing the state that a portable computer is connected to the fuel cell unit, in the embodiment of the present invention;

FIG. 3 is an exemplary block diagram of the fuel cell unit according to the embodiment of the present invention; and

FIG. 4 is an exemplary sectional view of the fuel cell unit according to the embodiment of the present invention.

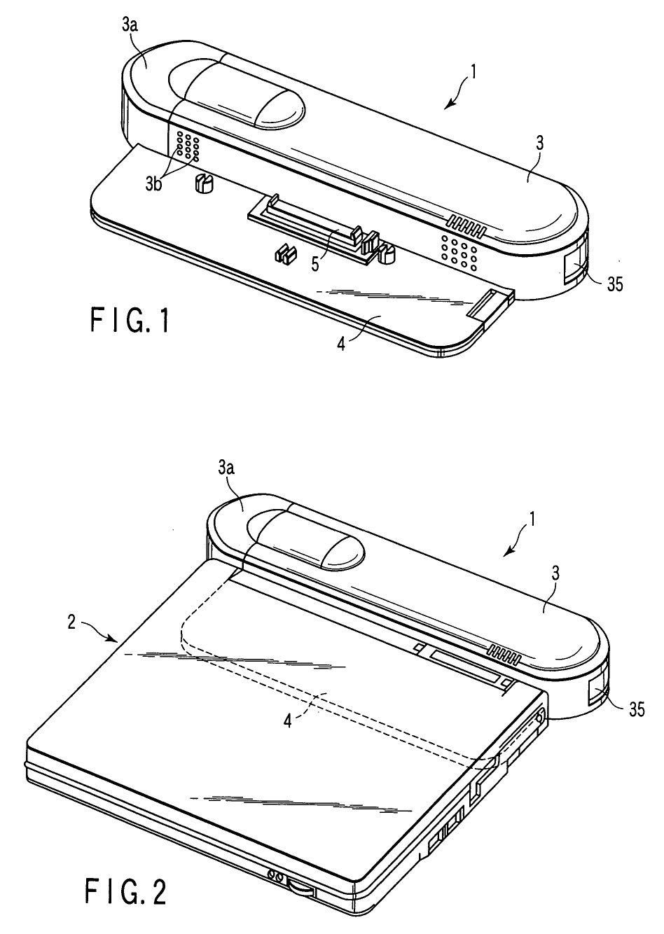

### DETAILED DESCRIPTION

Various embodiments according to the invention will be described hereinafter with reference to the accompanying drawings. In general, according to one embodiment of the invention, a fuel cell unit comprises a fuel supply path, a suction port, and an exhaust port. The fuel cell has a fuel pole and an air pole. The fuel supply path supplies fuel to the fuel pole of the fuel cell. The suction port takes in air for generation of electric power from the atmosphere. The exhaust port exhausts gaseous matter after generation of electric power discharged from the air pole of the fuel cell to the atmosphere. The suction port and exhaust port are opened in the directions different from each other.

FIG. 1 shows an active DMFC 1 using methanol as fuel. The DMFC 1 has a size usable as a power supply of a portable computer 2.

The DMFC 1 has a main body 3, and a mounting base 4. The main body 3 is shaped like a rectangular box along the width direction of the portable computer 2. The mounting base 4 projects from the front end of the main body 3 to mount the rear end of the portable computer 2. A power supply connector 5 is provided on the top of the mounting base 4. The power supply connector 5 is electrically connected to the portable computer 2 when the portable computer 2 is mounted on the mounting base 4.

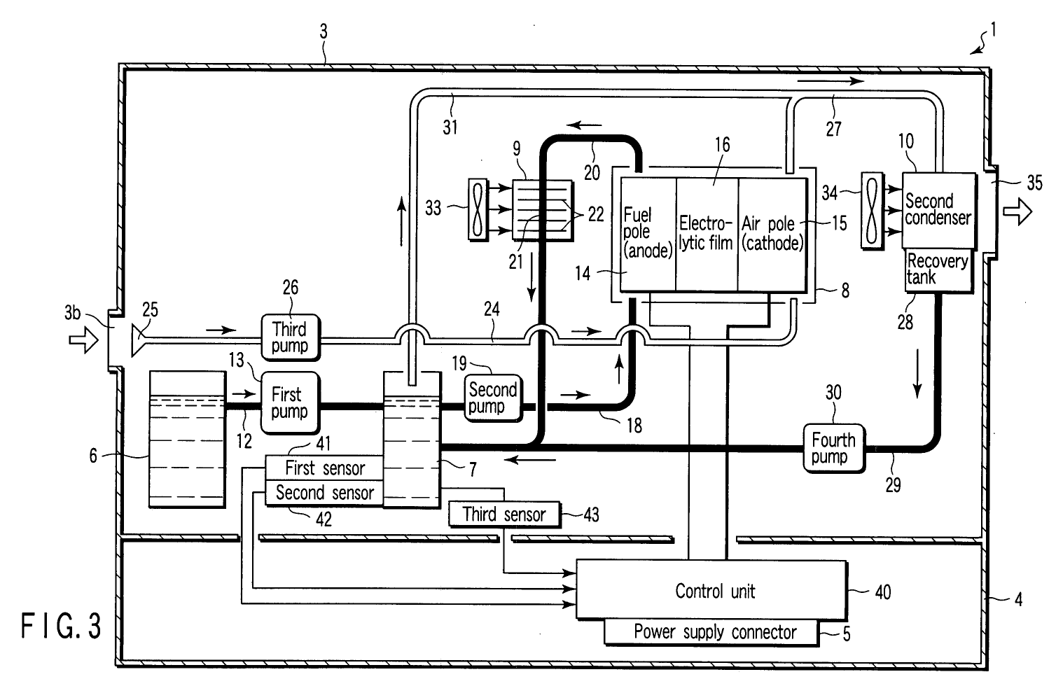

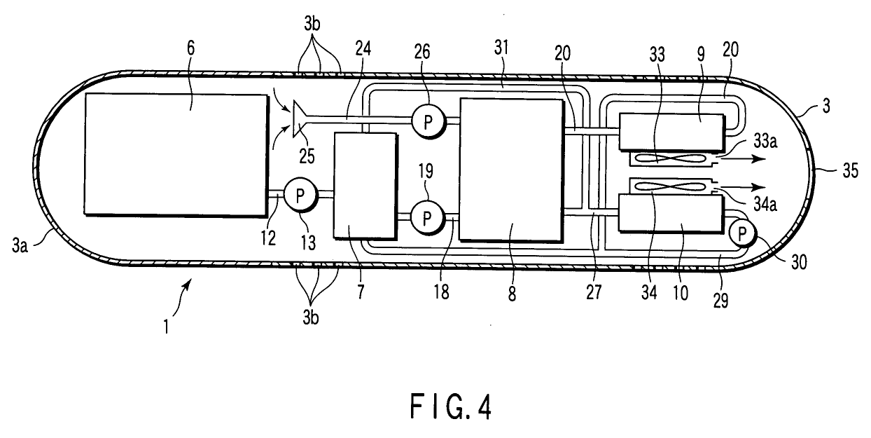

As shown in FIG. 3 and FIG. 4, the main body 3 contains a fuel cartridge 6, a mixing tank 7, a DMFC stack 8, a first condenser 9, and a second condenser 10. The fuel cartridge 6 is an example of a fuel supply source, and contains high-density methanol as fuel, for example. The fuel cartridge 6 is removably supported at one end along the longitudinal direction of the main body 3. The fuel cartridge 6 is covered with a cover 3a. The cover 3a is removably supported at one end of the main body 3 to facilitate replacement of the fuel cartridge 6.

The fuel cartridge 6 is connected to the mixing tank 7 through a first fuel supply tube 12. The first fuel supply tube 12 has a first pump 13 to feed high-density methanol to the mixing tank 7. The mixing tank 7 dilutes the high-density methanol, and generates methanol solution with a density of several percent to several tens percent. The mixing tank 7 adjoins the fuel cartridge 6.

The DMFC stack 8 is an example of a fuel cell to generate electric power by utilizing the chemical reaction of methanol. The DMFC stack 8 has a fuel pole (anode) 14, an air pole (cathode) 15, and an electrolytic film 16 interposed between these poles 14 and 15. The DMFC stack 8 is placed at the middle along the longitudinal direction of the main body 3.

The fuel pole 14 of the DMFC stack 8 is connected to the mixing tank 7 through the second fuel supply tube 18. The second fuel supply tube 18 is an example of a fuel supply path, and is connected to one end of the fuel pole 14. The second fuel supply tube 18 has a second pump 19. The second pump 19 feeds the methanol solution from the mixing tank 7 to the fuel pole 14.

The other end of the fuel pole 14 is connected to the mixing tank 7 through a fuel return tube 20. The fuel return tube 20 returns the unreacted methanol solution exhausted from the fuel pole 14 and the carbon dioxide generated by the oxidizing reaction in the fuel pole 14, to the mixing tank 7. The unreacted methanol solution and carbon dioxide are one of the exhausted substances exhausted from the fuel pole 14. Immediately after being exhausted from the fuel pole 14, the temperature of the methanol solution is over 60° due to the generation of electric power by the DMFC stack 8.

The first condenser 9 is provided at a point along the fuel return tube 20. The first condenser 9 cools the methanol solution returned from the fuel pole 14 to the mixing tank 7. The first condenser 9 has a tube 21 to flow the methanol solution, and two or more radiation fins 22 connected thermally to the tube 21.

The air pole 15 of the DMFC stack 8 is connected to the suction port 25 through the air supply tube 24. The suction port 25 takes in air for generation of electric power. The suction port 25 is placed at one end of the main body 3. The main body 3 has air vents 3b at the position corresponding to the suction port 25.

The air supply tube 24 is an example of an air supply path, and is connected to one end of the air pole 15. The air supply tube 24 has a third pump 26. The third pump 26 feeds air from the suction port 25 to the air pole 15. The third pump 26 is placed between the suction port 25 and DMFC stack 8.

The second condenser 10 is connected to the other end of the air pole 15 through the exhaust tube 27 as an exhaust path. The second condenser 10 cools substances such as vapor and water exhausted from the air pole 15. The second condenser 10 is connected to the downstream end of the exhaust tube 27.

The second condenser 10 has a recovery tank 28. The recovery tank 28 stores the water exhausted from the air pole 15 and water recovered from vapor. The gaseous matters dehydrated in the second condenser 10 are released from the second condenser 10.

The recovery tank 28 is connected to the fuel return tube 20 through a recovery tube 29. The recovery tube 29 has a fourth pump 30. The fourth pump 30 feeds water from the recovery tank 28 to the mixing tank 7 through the fuel return tube 20.

The exhaust tube 27 has a branch tube 31. The branch tube 31 is branched from the exhaust tube 27 between the air pole 15 and second condenser 10. The upstream end of the branch tube 31 is connected to the mixing tank 7. The branch tube 31 leads carbon dioxide from the mixing tank 7 to the second condenser 10 through the exhaust tuber 27. The carbon dioxide led to the second condenser 10 is released from the second condenser 10.

As shown in FIG. 4, the first condenser 9 and second condenser 10 are provided at the other end of the main body 3. The first condenser 9 and second condenser 10 are placed opposite to the fuel cartridge 6 through the DMFC stack 8. The first condenser 9 and second condenser 10 are opposite to each other with an interval. A first fan 33 and a second fan 34 are provided between the first condenser 9 and second condenser 10.

Therefore, in this embodiment, the fuel cartridge 6, mixing tank 7, third pump 26, DMFC stack 8, first condenser 9 and second condenser 10 are aligned along the longitudinal direction of the main body 3.

The first fan 33 overlaps the first condenser 9. When the first fan 33 operates, a flow of cooling air is formed toward the first fan 33 through the first condenser 9. The first condenser 9 is cooled by this cooling air. After cooling the first condenser 9, the cooling air is exhausted from a discharge port 33a of the first fan 33.

The second fan 34 overlaps the second condenser 10. When the second fan 34 operates, a flow of cooling air is formed toward the second fan 34 through the second condenser 10. The second condenser 10 is cooled by this cooling air. After cooling the second condenser 10, the cooling air is exhausted from a discharge port 34a of the second fan 34. Impurities such as the carbon dioxide exhausted from the second condenser 10 are also exhausted from the discharge port 34a by the cooling air.

As shown in FIG. 4, the discharge ports 33a and 34a of the first and second fans 33 and 34 are opened to direct to the other end of the main body 3. The opening directions of the discharge ports 33a and 34a are reverse to the opening direction of the suction port 25.

The main body 3 has an exhaust port 35 at the other end. The exhaust port 35 faces the discharge ports 33a and 34a of the first and second fans 33 and 34, and is opened in the direction different from the suction port 25. The cooling air and impurities such as the carbon dioxide discharged from the discharge ports 33a and 34a are exhausted outside the main body 3 through the exhaust port 35.

As shown in FIG. 3, the DMFC 1 has a control unit 40. The control unit 40 is contained in the mounting base 4 of the DMFC 1, and is electrically connected to the power supply connector 5 and DMFC stack 8. The control unit 40 controls the density and amount of the methanol solution generated in the mixing tank 7. The control unit 40 exchanges information with the portable computer 2, and controls the power supplied to the portable computer 2.

The density of the methanol solution is adjusted by the control unit 40 by controlling the amount of the high-density methanol supplied from the fuel cartridge 6 to the mixing tank 7, the amount of the unreacted methanol solution returned from the fuel pole 14 of the DMFC stack 8, and the amount of the water returned from the air pole 15 of the DMFC stack 8.

Concretely, the mixing tank 7 has a first sensor 41, a second sensor 42, and a third sensor 43. The first sensor 41 detects the volume of the methanol solution in the mixing tank 7. The second sensor 42 detects the temperature of the methanol solution. The third sensor 43 detects the density of the methanol solution. The information about the methanol solution detected by the first to third sensors 41, 42 and 43 is sent to the control unit 40. Based on the information from the first to third sensors 41, 42 and 43, the control unit 40 controls the first pump 14 and the fourth pump 30. This adjusts the amount of the high-density methanol flowing from the fuel cartridge 6 to the mixing tank 7 and the amount of the water flowing from the recovery tank 28 to the mixing tank 7. As a result, the density of methanol solution is controlled to a value capable of keeping good electric power generation performance.

Next, an explanation will be given on the generation of electric power by the DMFC 1.

The high-density methanol stored in the fuel cartridge 6 is fed to the mixing tank 7 by the first pump 13. The water recovered from the air pole 15 of the DMFC stack 8 and the unreacted low-density methanol exhausted from the fuel pole 14 of the DMFC stack 8 are returned to the mixing tank 7. Thus, the high-density methanol is diluted when mixed with the water and the low-density methanol in the mixing tank 7. As a result, a methanol solution with a fixed density is generated.

The methanol solution generated in the mixing tank 7 is fed to the fuel pole 14 of the DMFC stack 8 by the second pump 19. In the fuel pole 14, methanol reacts with water and oxidizes, and generates hydrogen ions, carbon dioxide and electrons. The hydrogen ions penetrate the electrolytic film 16 of the DMFC stack 8, and reach the air pole 15.

The carbon diode generated in the fuel pole 14 is led to the first condenser 9 together with the unreacted methanol solution. The carbon dioxide is cooled by the cooling air from the first fan 33, and returned to the mixing tank 7 through the fuel return tube 20. The carbon dioxide returned to the mixing tank 7 vaporizes in the mixing tank 7, and flows into the exhaust tube 27 from the branch tube 31.

Air for generation of electric power is taken in from the suction port 25, and fed to the air pole 15 of the DMFC stack 8 through the third pump 26. In the air pole 15, oxygen in the air deoxidizes by combining with hydrogen ions and electrons, and generates vapor. At this time, electricity flows in an external circuit connected between the fuel pole 14 and air pole 15, and electric power is generated.

The vapor generated in the air pole 15 flows into the exhaust tube 27, joins the carbon dioxide from the mixing tank 7 in the exhaust tube 27, and is led to the second condenser 10. In the second condenser 10, the vapor is cooled by the cooling air from the second fan 34, and becomes water. This water is temporarily stored in the recovery tank 28. The gaseous matter dehydrated and including impurities such as the carbon dioxide is exhausted from the second condenser 10, and discharged toward the exhaust port 35 from the discharge port 34a of the second fan 34 together with the cooling air passing through the second condenser 10.

The water stored in the recovery tank 28 is fed to the mixing tank 7 through the fourth pump 30, and reused as water to dilute high-density methanol.

In the above described DMFC 1, the suction port 25 to take in air for generation of electric power is placed at one end along the longitudinal direction of the main body 3, and the exhaust port 35 to exhaust gaseous matter discharged from the DMFC stack 8 after generation of electric power is placed at the other end of the main body 3. In other words, the mixing tank 7, third pump 26, DMFC stack 8, first condenser 9 and second condenser 10 are placed between the suction port 25 and exhaust port 35, and these suction port 25 and exhaust port 35 are separated from each other in the longitudinal direction of the main body 3.

Further, the suction port 25 and exhaust port 35 are opened to direct reversely to each other at the position separated away in the longitudinal direction of the main body 3.

Therefore, even if gaseous matter with a low oxygen density and including impurities such as carbon dioxide and methanol is exhausted from the exhaust port 35, the gaseous matter is exhausted in the direction reverse to the suction port 25, and the suction port 25 hardly takes in the gaseous matter exhausted from the exhaust port 35. This can prevent a drop in the electric power generation performance, and provide a high output.

In the above embodiment, the suction port and exhaust port are opened in the directions reverse to each other, but the invention is not limited to this. The suction port and exhaust port may be opened in the direction orthogonal to each other.

The fuel cell unit according to the invention is not limited to a portable computer. It may be applicable as a power supply for other electronic apparatus such as a portable information terminal.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A fuel cell unit comprising:
a fuel cell having a fuel pole and an air pole;
a fuel supply path to supply fuel to the fuel pole of the fuel cell;
a suction port to take in air for generation of electric power; and
an exhaust port to exhaust gaseous matter after generation of electric power discharged from the air pole of the fuel cell,
wherein the suction port and exhaust port are opened in the directions different from each other.

2. The fuel cell unit according to claim 1, wherein the suction port is connected to the air pole of the fuel cell through an air supply path, and the air supply path has a pump to feed the air taken in from the suction port to the air pole.

3. The fuel cell unit according to claim 2, wherein the fuel cell and pump are placed between the suction port and exhaust port.

4. The fuel cell unit according to claim 1, wherein the gaseous matter after generation of electric power is exhausted from the exhaust port through a fan.

5. The fuel cell unit according to claim 1, further comprising a main body to contain the fuel cell, the main body having one end and the other end placed opposite to the one end, wherein the suction port is placed at the one end of the main body, and the exhaust port is placed at the other end of the main body.

6. A fuel cell unit comprising:
a fuel cell having a fuel pole and an air pole;
a mixing tank which generates diluted fuel by mixing a fuel supplied from a fuel supply source with an exhausted substance exhausted from the fuel cell;
a fuel supply path which supplies the diluted fuel generated in the mixing tank to the fuel pole of the fuel cell;
an air supply path having a suction port, the air supply path taking in air for generation of electric power from the suction port and feeding the air to the air pole of the fuel cell; and
an exhaust path having an exhaust port, the exhaust path exhausting gaseous matter after generation of electric power discharged from the air pole of the fuel cell,
wherein the suction port and exhaust port are opened in the directions different from each other.

7. The fuel cell unit according to claim 6, wherein the exhausted substance is unreacted diluted fuel exhausted from the fuel pole of the fuel cell.

8. The fuel cell unit according to claim 6, wherein the exhausted substance is vapor exhausted from the fuel pole of the fuel cell.

9. The fuel cell unit according to claim 6, wherein the air supply path has a pump to feed the air taken in from the suction port to the air pole.

10. The fuel cell unit according to claim 6, further comprising a main body to contain the fuel cell, fuel supply source and mixing tank, the main body having one end and the other end placed opposite to the one end, wherein the suction port is placed at the one end of the main body, and the exhaust port is placed at the other end of the main body.

11. The fuel cell unit according to claim 10, wherein the fuel cell, fuel supply source and mixing tank are placed between the suction port and exhaust port.
